(19) United States
(12) Patent Application Publication
(10) Pub. No.: US 2003/0110955 A1
(43) Pub. Date: Jun. 19, 2003

(54) Secondary heat reflector

(76) Inventor: Joseph Behm, San Diego, CA (US)

Correspondence Address: D. Whitlow Bivens, Musick, Peeler & Garrett, LLP, Suite 1900, 225 Broadway, San Diego, CA, 92101, US

(21) Appl. No.: 10/286,195

(22) Filed: Nov. 1, 2002

Related U.S. Application Data
(63) Continuation-in-part of application No. 09/848,703, filed on May 3, 2001, now Pat. No. 6,497,175.
(60) Provisional application No. 60/201,827, filed on May 3, 2000.

(51) Int. Cl. A23P 1/00

(52) U.S. Cl. 99/427

(57) ABSTRACT

Reflective heat shield for increasing the efficiency and reducing the cooking time for rotisserie cookers. The heat shield comprises a reflective portion contoured to reflect heat energy back onto food and a base portion designed to support the reflective portion proximate to the food. The heat shield is located between the food and the front door of the rotisserie cooker.

### CLAIM FOR BENEFIT AND PRIORITY

This application is a continuation-in-part application and claims the benefit of and priority from U.S. application Ser. No. 09/848,703 filed May 3, 2001 which is a continuation-in-part application that claims the benefit of and priority from U.S. Provisional Application No. 60/201,827 filed May 3, 2000.

### BACKGROUND OF THE INVENTION

1. Field of the Invention

The invention relates generally to the roasting of foods in rotisserie ovens. More specifically, the invention relates to an apparatus and method for reducing the time required to roast foods in a rotisserie oven.

With the growth of rotisserie sales worldwide it has been noted in that the design of many rotisseries plays a significant role in extending the roasting time required to roast various foods. Generally speaking rotisserie heating elements are located towards the rear of the rotisserie enclosure. U.S. Pat. Nos. 6,142,064 and 6,279,462 provide illustrations of typical counter-top rotisseries and show the typical location of the heating elements within the rotisserie.

2. Description of Related Art

U.S. Pat. No. 6,279,462 discloses an electric barbecuing cooker. The main body of the cooker is curved at the top to facilitate easy access to the cooking chamber and easy cleaning. The cooking chamber is accessed through front top and front bottom doors.

U.S. Pat. No. 6,142,064 discloses an enclosed rotisserie with added convenience. The cooking chamber is accessed through an inclined class door.

None of the foregoing prior art suggests the apparatus or method for decreasing the time required to roast foods in a rotisserie oven.

### SUMMARY OF THE INVENTION

The present invention provides a method and apparatus for addressing a significant obstacle in roasting foods in a rotisserie oven. The conventional design of rotisserie ovens leads to substantial inefficiency of heat utilization. Specifically, it is believed that a large amount of energy escapes from most rotisserie ovens through the front of the oven. The present invention offers an apparatus and method to increase the efficiency of a rotisserie oven by reflecting energy that otherwise would escape through the front of the oven back onto the food being cooked or roasted.

One embodiment of the invention comprises a secondary heat reflector. The heat reflector is positioned between the food and the front door of the rotisserie opposite the location of the heating elements in most rotisseries. This effectively creates a second enclosure within the rotisserie's cooking chamber. The heat reflector will reflect heat radiating from the electrical heating elements back onto the food being cooked.

One preferred embodiment of the apparatus is a reflective surface contoured or curved to partially surround the rotisserie shaft made from a heat-resistant material such as stainless steel or any other suitable material known in the art. If desired, a clear window may be incorporated into the apparatus to allow viewing of the cooking food while the heat shield is in place. Such a window may be made of glass or any other suitable material known in the art. Additionally, a handle may be attached to the apparatus to facilitate the installation and removal of the heat shield.

The heat shield is advantageously simple and easy to install and remove. Some rotisserie ovens provide a slotted bottom surface of the cooking chamber such as a grease pan. Accordingly, in one embodiment, offered without intent to limit the invention, the heat shield may be provided with tabs or legs designed to be fitted into one or more slots in the bottom surface of the cooking chamber. Additional tabs, legs or other supports may be included to enhance the stability of the heat shield. In an alternative embodiment, offered without intent to limit the invention, the heat shield is provided with a support structure adapted to sit on a flat bottom surface. In a third alternative embodiment, offered without intent to limit the invention, the heat shield comprises at least two separate pieces and the piece responsible for supporting the heat shield may be selected from a number of alternative designs to best suit the rotisserie in which the heat shield is installed. Any other method, known in the art, of supporting or positioning the heat shield within the cooking chamber of a rotisserie oven is considered to be within the scope of the invention.

The heat shield disclosed herein has been shown to reduce the roasting time by as much as 47%. For example, to roast one pound of green coffee beans to a full city roast in the Ronco® Showtime Rotisserie required 53 minutes of roasting without the heat shield. With the heat shield, the one pound of green coffee beans was roasted to full city in 28 minutes.

Accordingly, the present invention increases the convenience of the rotisserie cooking process and saves energy by reducing the time required to cook foods.

In operation, the rotisserie is opened and the food to be cooked is loaded into the cooking chamber. Next, the heat shield is installed between the food and the door or doors to the cooking chamber. The cooking chamber door or doors are then closed and the rotisserie is activated. Once the food is cooked to the desired degree, the cooking chamber door or doors are opened, the heat shield is removed from the cooking chamber, and the food is removed from the cooking chamber.

The aforementioned objects and advantages of the present invention, as well as additional objects and advantages thereof, will be more fully understood from the following detailed description of the preferred embodiments when taken in conjunction with the following drawings. It should be understood, however, that the detailed description and the specific examples, while representing the preferred embodiments, are given by way of illustration only and should not be construed in a limiting sense.

### BRIEF DESCRIPTION OF THE DRAWINGS

FIG. 1 is a perspective view of one embodiment of a heat shield constructed in accordance with the principles of the present invention shown in relation to a rotisserie roasting drum and some rotisserie heating elements.

FIG. 2 is a side view of one embodiment of a heat shield constructed in accordance with the principles of the present invention shown in relation to a rotisserie roasting drum and some rotisserie heating elements.

FIG. 3 is a front view of one embodiment of a heat shield constructed in accordance with the principles of the present invention.

FIG. 4 is a side view of one embodiment of a heat shield constructed in accordance with the principles of the present invention shown in relation to a rotisserie roasting drum and some rotisserie heating elements.

### DETAILED DESCRIPTION OF THE PREFERRED EMBODIMENTS

The following description is of the best presently contemplated modes of carrying out the invention. This description is made for the purpose of illustrating the general principles of the invention and should not be taken in a limiting sense.

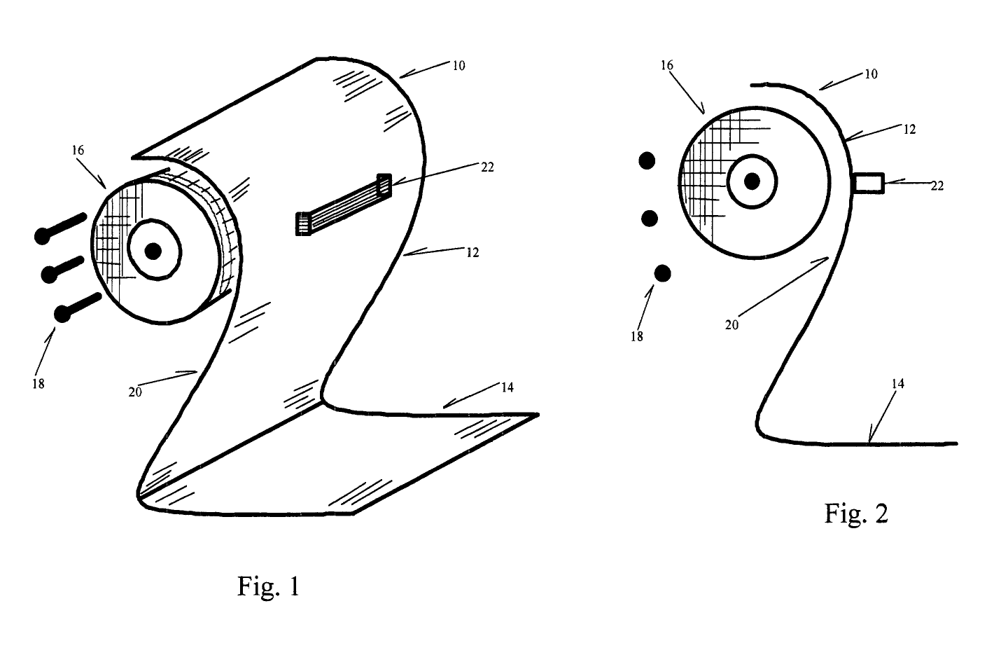

In accordance with the principles of the present invention, FIGS. 1 and 2 show one preferred embodiment of the heat shield designated generally as 10. As shown, heat shield 10 comprises a reflecting portion 12 and a base portion 14. The reflecting portion 12 is contoured to partially surround the food (not shown) being cooked or roasted. In FIGS. 1 and 2, a roasting basket 16 is shown installed proximate to heating elements 18. The surface 20 of reflecting portion 12 facing roasting basket 16 and heating elements 18 is provided with a material capable of reflecting heat energy. One preferred embodiment of the heat shield 10 is constructed out of stainless steel, however, other suitable materials or combinations of materials may be used.

Heat shield 10 may be provided with a handle 22 to facilitate the installation and removal of heat shield 10 within the cooking compartment of a rotisserie. As shown in FIGS. 1 and 2, base portion 14 comprises a relatively flat plane attached to reflecting portion 12 and adapted to rest on virtually any flat surface. Preferably, the embodiment of heat shield 10 shown in FIGS. 1 and 2 is designed and constructed such that the center of gravity of reflecting portion 12 is located somewhere over base portion 14 so that heat shield 10 stands upright on virtually any flat surface.

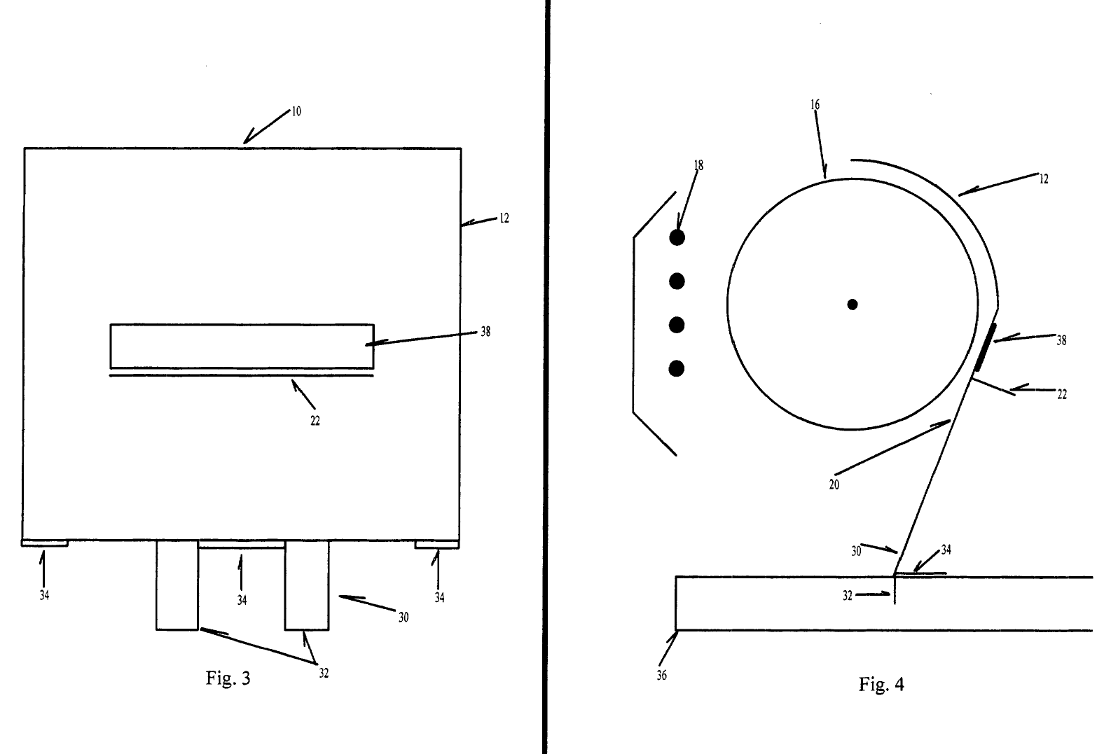

In accordance with the principles of the present invention, FIGS. 3 and 4 show a second preferred embodiment of the heat shield designated generally as 10. As shown, heat shield 10 comprises a reflecting portion 12 and a base portion generally designated as 30. Base portion 30 may comprise tabs 32 and tabs 34. Tabs 32 are adapted to fit within slots in grease pan 36 (shown in FIG. 4). Tabs 34 are adapted to rest on top of grease pan 36 and stabilize heat shield 10. Alternative arrangements of tabs designed to mate with grease pan 36 and stabilize heat shield 10 are considered to be within the scope of the invention.

As shown in FIGS. 3 and 4, the reflecting portion 12 of heat shield 10 may be provided with a handle 22 for facilitating the installation and removal of heat shield 10 and a window 38 for viewing the food as it is cooking.

Although the invention has been described herein with references to specific embodiments, many modifications, variations, changes, omissions, and substitutions therein will readily occur to those skilled in the art. Accordingly, all such variations changes, omissions, and substitutions are included within the intended scope of the invention. It is intended that the present invention be limited solely by the scope of the following claims:

What is claimed is:

1. A reflective heat shield adapted to fit within a rotisserie oven comprising:
a reflecting portion shaped to at least partially reflect heat energy onto food being cooked within said rotisserie oven;
a base portion connected to said reflecting portion and adapted to support said reflecting portion proximate to said food.

2. The reflective heat shield of claim 1 wherein said base portion comprises a relatively flat plane adapted to rest on a relatively flat surface.

3. The reflective heat shield of claim 2 wherein a center of gravity of said reflecting portion is located somewhere over said base portion so that said reflective heat shield stands upright when placed on a relatively flat surface.

4. The reflective heat shield of claim 1 wherein said base portion comprises at least one tab adapted to fit into a slot in a bottom surface of a rotisserie oven.

5. The reflective heat shield of claim 4 wherein said base portion comprises at least one second tab adapted to contact a bottom surface of a rotisserie oven and provide stability to said reflective heat shield.

6. The reflective heat shield of claim 1 further comprising a window located on said reflecting portion to allow a rotisserie oven user to view food while said food is cooking.

7. The reflective heat shield of claim 2 further comprising a window located on said reflecting portion to allow a rotisserie oven user to view food while said food is cooking.

8. The reflective heat shield of claim 3 further comprising a window located on said reflecting portion to allow a rotisserie oven user to view food while said food is cooking.

9. The reflective heat shield of claim 4 further comprising a window located on said reflecting portion to allow a rotisserie oven user to view food while said food is cooking.

10. The reflective heat shield of claim 5 further comprising a window located on said reflecting portion to allow a rotisserie oven user to view food while said food is cooking.

11. The reflective heat shield of claim 1 wherein said reflecting portion is at least partially curved.

12. The reflective heat shield of claim 2 wherein said reflecting portion is at least partially curved.

13. The reflective heat shield of claim 3 wherein said reflecting portion is at least partially curved.

14. The reflective heat shield of claim 4 wherein said reflecting portion is at least partially curved.

15. The reflective heat shield of claim 5 wherein said reflecting portion is at least partially curved.

16. A reflective heat shield adapted to fit within a rotisserie oven comprising:
means for reflecting heat energy onto food being cooked within said rotisserie oven;
means for supporting and positioning said means for reflecting in a position whereby heat energy is reflected onto food being cooked within said rotisserie oven;
said means for supporting and positioning connected to said means for reflecting.

17. The reflective heat shield of claim 16 further comprising a window positioned within said means for reflecting to allow said food to be viewed while cooking.

18. The reflective heat shield of claim 16 wherein said means for reflecting is at least partially curved.

19. A method of reducing the time required to cook food within a rotisserie oven having a door for accessing a cooking chamber within said rotisserie oven and having food to be cooked positioned within said cooking chamber of said rotisserie oven comprising the step of:
installing a reflective heat shield adapted to fit within said rotisserie oven proximate to said food to be cooked and between said food and said door.

20. The method of claim 19 wherein said reflective heat shield comprises a reflecting portion which is at least partially curved.
